(19) United States
(12) Patent Application Publication
(10) Pub. No.: US 2015/0151340 A1
(43) Pub. Date: Jun. 4, 2015

(54) Assembly for Chemical Container Incising, Purging, and Water Rinsing

(71) Applicant: Ethan Eck, Kingman, KS (US)

(72) Inventor: Ethan Eck, Kingman, KS (US)

(21) Appl. No.: 14/616,009

(22) Filed: Feb. 6, 2015

Related U.S. Application Data
(60) Provisional application No. 61/965,796, filed on Feb. 7, 2014.

(51) Int. Cl. B08B 9/093; B08B 9/20

(52) U.S. Cl. CPC B08B 9/093; B08B 9/20

(57) ABSTRACT

An assembly for chemical container incising, purging, and water rinsing incorporating a frame defining a processing space; a knife and nozzle within the processing space, the knife having a cutting edge and the nozzle being positioned rearwardly from the cutting edge; a first conduit communicating with the nozzle; a bracket component within the processing space and adapted for supporting the chemical container; a motion actuator within the processing space and operatively interconnecting the frame and a component selected from the group consisting of the knife and nozzle component and the bracket component, the motion actuator being adapted for, upon the bracket component's support of the chemical container, moving the selected operatively interconnected component between first and second positions, the blade and nozzle component residing within the chemical container upon movement to the second position, and the blade and nozzle component displacing from each other upon movement to the first position.

### CLAIM OF PRIORITY FROM PREVIOUSLY FILED PROVISIONAL PATENT APPLICATION

This non-provisional patent application claims the benefit of and priority from U.S. provisional patent application No. 61/965,796 filed Feb. 7, 2014. The inventor disclosed in and applicant of said provisional application is the same as the inventor and applicant of the instant application. Substantial commonality exists between the subject matter of said provisional patent application and that of the instant application.

### FIELD OF THE INVENTION

This invention relates to apparatus and assemblies which are adapted for assisting in the transfer of fluids within relatively small chemical containers into larger chemical tanks. The invention further relates to such apparatus and assemblies which are further adapted for assistance in subsequently rinsing such relatively small chemical containers.

### BACKGROUND OF THE INVENTION

Agricultural herbicides and pesticides are often contained and distributed to farm operators within small two to three gallon plastic jugs or canisters. In order for such chemicals to be dispensed over crops or crop ground by farm equipment such an agricultural sprayer having a chemical tank, fluids within such small containers are typically manually poured one-by-one by the farm operator into such tank. Such manual pouring process is typically laborious and is time consuming. Following such manual one-by-one pouring of the small chemical containers, additional task steps of triple rinsing the containers must be further performed in a further laborious and time consuming manner.

The instant inventive assembly for chemical container incising, purging, and water rinsing incorporates specialized frame mounted mechanisms for automating steps described above, advantageously resulting in time and labor savings.

### BRIEF SUMMARY OF THE INVENTION

A first structural component of the instant inventive assembly for chemical container incising, purging, and water rinsing comprises a frame which forms, surrounds, and defines a chemical container processing space. In a preferred embodiment, the frame element comprises a substantially hermetically sealable processing chamber having a ceiling including a lid, a plurality of side walls, and a chemical collecting floor including a drain port. Where the frame comprises such hermetic chamber, lower pedestal or foot support elements are provided for securely positioning the frame upon the ground for operation in the manner of a staging receptacle which receives liquid chemicals prior to transmission to a larger agricultural chemical tank.

Suitably, the frame may be alternatively configured for mounting and operation within such agricultural chemical tank. To enable the operator of the inventive assembly within such tank space operation environment, the frame element is preferably alternately configured as an open support lattice. Frame mounting means such as tank lip engaging hooks which may support and suspend such frame within such tank are also preferably provided.

A further structural component of the instant inventive assembly comprises a component in the nature of a combined knife and nozzle assembly, such component being positioned for operation within the frame's interior processing space. In a preferred embodiment, the knife and nozzle component has a forward and preferably upper chemical container incising edge. Also in the preferred embodiment, such component is adapted for positioning its nozzle element rearwardly from such forward cutting edge so that, upon incising passage by the knife through a wall of a chemical container and upon entry of the knife element into the interior space of the chemical container, the nozzle element immediately follows and correspondingly enters the interior of the chemical container.

Incisions cut by the knife element through the wall or walls of the chemical container advantageously allow the liquid contents of the container to purge from the container ejecting outwardly therefrom and into the frame's interior processing space. The corresponding position of the nozzle element within the container allows for interior water spraying operation which advantageously automatically rinses the chemical container.

In the preferred embodiment, the knife and nozzle components' knife element comprises a pair of splayed, rearwardly angled, and laterally canted blades which form an inverted “V” configuration. Also, in the preferred embodiment, the nozzle element is supported and positioned between the legs of such inverted “V”.

A further structural component of the instant inventive assembly comprises a first conduit which communicates with the nozzle and which carries rinse water from without the frame into the frame's interior processing space. In a preferred embodiment, an on/off valve is associated with the first conduit so that the operator may selectively require that rinse water flows occur subsequent to chemical purging and during the presence of the knife and nozzle component within the interior of the chemical container.

A further structural component of the instant inventive assembly comprises a bracket component located within the frame's interior processing space, the bracket component being adapted for securely supporting and holding the chemical container during impinging and incising engagement with the knife and nozzle component.

A further structural component of the instant inventive assembly comprises a motion actuator positioned within the frame's processing space. In the preferred embodiment, the motion actuator operatively interconnects the frame and a component selected from the group consisting of the knife and nozzle component and the bracket component.

In a preferred embodiment, the motion actuator is adapted for, upon support by the bracket component of the chemical container, moving the selected operatively interconnected component between first and second positions. Upon passage of the blade and nozzle component through a wall of the chemical container and into such container's interior space, such selected operatively interconnected component resides at the second position. Upon a movement of the bracket component away from the blade and nozzle component constituting the relative displacement of such components from each other, the operatively interconnected component effectively moves to the first position.

In a preferred embodiment of the instant inventive assembly, the selected operatively interconnected component comprises the knife and nozzle component, and the motion actuator comprises a slide or roller track which guides reciprocating motions of the knife and nozzle component toward and away from the bracket component, and toward and away from a chemical container supported by such bracket. Alternatively, where the selected operatively interconnected component comprises the bracket which holds and supports the chemical container, the motion actuator may similarly comprise a slide or roller track which in a similar fashion guides reciprocating motions of the bracket component and the chemical container toward and away from the knife and nozzle component. Regardless of which component among the knife and nozzle and bracket components constitutes the selected operatively interconnected component, movement to the second position causes the knife and nozzle component to reside within a chemical container supported by the bracket component.

In a preferred embodiment of the instant inventive assembly, the motion actuator comprises a linear motion actuator selected from the group consisting of pneumatic cylinders, hydraulic cylinders, chain and sprocket combinations, pulley and belt combination, gear trains, pivoting lever arm actuators, plunger actuators, pull handle actuators, electric motor actuators, pneumatic motor actuators, hydraulic motor actuators, and screw shaft actuators, such selected linear motion actuator preferably being connected operatively to the selected bracket component or to the knife and nozzle component, as the case may be, for driving of reciprocating motions of such selected component.

In operation of the instant inventive assembly for chemical container incising, purging, and water rinsing, an operator may initially place the chemical container with the assembly's bracket component for firm support and holding within the frame's interior processing space. Thereafter, the operator may actuate the assembly's motion actuator, resulting in an intersecting and incising relative positioning of the knife and nozzle component and the bracket component such that the knife and nozzle component or the bracket component, as the case may be, occupies the second position. During the selected operatively connected component's approach to the second position, the blades of the knife and nozzle component incise the wall of the chemical container, allowing the fluid contents of the container to outwardly purge into the frame's interior processing space.

Following such chemical purging, pressurized water may be introduced into the first conduit causing such water to emit from the knife and nozzle component's nozzle for water spraying and rinsing of the interior of the purged chemical container. Thereafter, the motion actuator may be counter-actuated for withdrawal of the operatively connected knife and nozzle component or bracket component, as the case may be, toward the first position.

Thereafter, the operator may extract the purged and rinsed chemical container form the interior processing space, and may immediately insert a next successive chemical container into the bracket component. Successive repetitions of the steps set forth above easily and rapidly purges and rinses multiple chemical containers.

Accordingly, objects of the instant inventive include the provision of an assembly for chemical container incising, purging, and water rinsing which incorporates structural elements as described above, and which arranges such elements in relation to each other in manners described above for the achievement of the beneficial functions described above.

Other and further objects, benefits, and advantages of the instant inventive assembly will become known to those skilled in the art upon review of the Detailed Description which follows, and upon review of the appended drawings.

### BRIEF DESCRIPTION OF THE DRAWINGS

FIG. 1 is a perspective view of a preferred embodiment of the instant inventive assembly for incising, purging, and water rinsing a chemical container.

FIG. 2 is a sectional view as indicated in FIG. 1.

FIG. 3 is an alternate sectional view as indicated in FIG. 1, the view showing a knife and nozzle component at a downwardly displaced first position.

FIG. 4 redepicts the structure of FIG. 3, the view of FIG. 4 alternatively showing a knife and nozzle component at an upwardly displaced second position.

FIG. 5 redepicts the structure of FIG. 1, the view of FIG. 5 alternatively showing an electric motor linear motion actuator component.

FIG. 6 is a sectional view as indicated in FIG. 5.

FIG. 7 alternatively redepicts the structure of FIG. 1, the view of FIG. 7 showing a plunger linear motion actuator component.

FIG. 8 is a sectional view as indicated in FIG. 7.

FIG. 9 is an alternative sectional view as indicated in FIG. 5, the view of FIG. 9 showing a vertically and reciprocatingly moveable container holding bracket.

FIG. 10 redepicts the structure of FIG. 3, the view of FIG. 10 alternatively showing a frame component in an open lattice configuration and further alternatively showing such frame mounted for operation within an agricultural chemical tank.

### DETAILED DESCRIPTIONS OF PREFERRED EMBODIMENTS

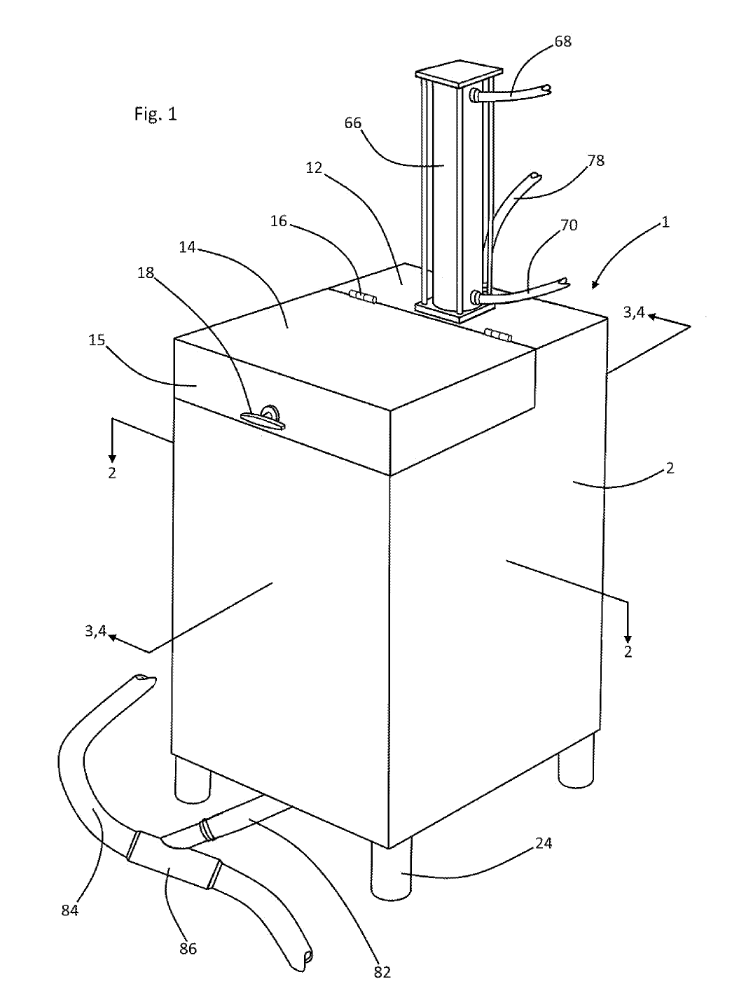

Referring now to the drawings, and in particular to Drawing FIGS. 1-4, one of the preferred embodiments of the instant inventive assembly for chemical container incising, purging, and water rinsing is referred to generally by Reference Arrow 1. In such embodiment, the inventive assembly comprises a frame which surrounds, forms, and volumetrically defines a substantially hermetically closed or sealed chemical container processing space 3.

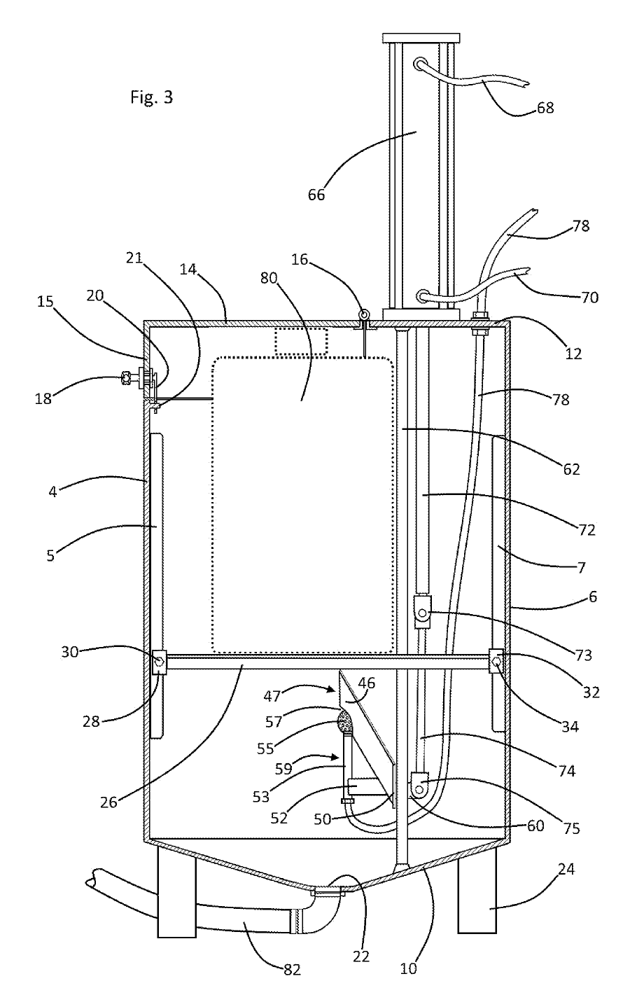

In the embodiment of FIGS. 1-4, the frame element of the assembly suitably comprises a plurality of substantially imperforate and fluids sealing side walls 2, 4, 6, and 8, in combination with a floor 10 and a ceiling 12. In such embodiment, the floor 10 is preferably configured as depicted in FIG. 3 to slope centrally in the manner of a drain basin toward a fluids outlet port 22. The upper ceiling 12 of such frame is preferably configured to include a lid 14 mounted upon hinges 16, such lid 14 having a lateral latch mounting flange 15.

The substantially hermetic and fluid sealing frame of FIGS. 1-4 is preferably adapted for use and operation upon ground or floor surfaces, such adaptation comprising a plurality of pedestals or feet 24 which are fixedly attached to and extend downwardly from the undersurface of the floor 10. The hermetic character of the FIGS. 1-4 frame advantageously allows for operation of the assembly without spattering ejections of potentially hazardous chemicals.

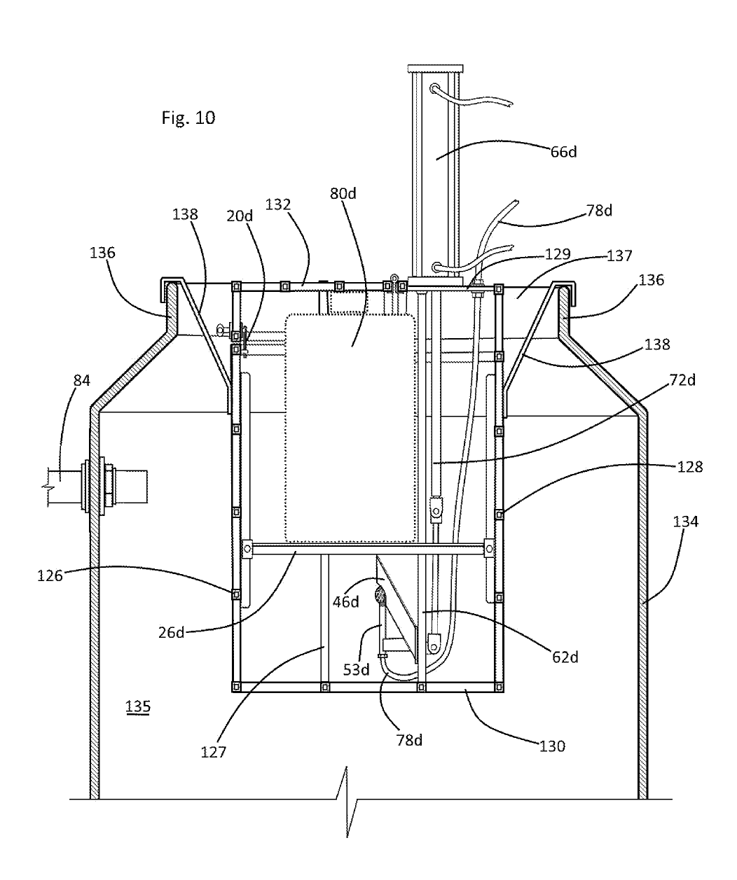

Referring simultaneously to FIGS. 1-4 and 10, the frame component of the instant inventive assembly may alternatively be configured as indicated in FIG. 10 to incorporate an open lattice of square tubing which forms a plurality of side walls 126, 127, and 128, a ceiling 129 including a lid 132 attached by hinge 133, and substantially open lower end 130. Where the frame component is configured as such lattice frame, it may be fitted for operation within the interior 135 of a large agricultural chemical mixing and dispensing tank 134. Where such open lattice frame configuration frame is adopted, means for securing, positioning, and mounting such frame within the interior 135 of such chemical tank 134 are preferably provided, such means suitably comprising a plurality of hooks 138 which may engage the lip 136 of the tank 134, and may suspend the frame at and within the tank's upper opening 137. Such tank engaging hooks 136 are intended as being representative of other suitable frame positioning and mounting means, such as tank wall bracket or tank floor mounts (not depicted within views), which may similarly secure an open lattice frame upon the floor or side wall of such tank 134.

Referring simultaneously to Drawing FIGS. 1-4, the instant inventive assembly preferably further comprises a knife and nozzle combination or component, such component being operatively positioned within the frame's chemical container processing space 3. In the FIGS. 1-4 embodiment, the knife and nozzle component's knife element is identified by Reference Arrow 47, such knife 47 preferably comprising a splayed pair of blades 46 and 48, such blades preferably having sharpened forward or upper container incising edges. In all embodiments of the instant inventive assembly, the knife's blades 46 and 48 are configured in the form of the legs of an inverted “V” whose upper point or vertex may function as a lance for perforating wall surfaces of plastic chemical containers. In such preferred inverted “V” configuration of the blades 46 and 48, their lower or rearward ends are preferably laterally canted so that, upon incising impingements with chemical container 80, both the floor and side wall of the container are incised in an “L” shape “U” slot, such incision enhancing fluid purging speed. Further functions of such lateral leg cants are described below.

The nozzle element of the knife and nozzle component is referred to generally by Reference Arrow 59, such nozzle 59 preferably comprising a rigid tube 53 having a lower inlet end and an upper outlet end. Such nozzle 59 preferably further comprises an upper spray head 55 mounted in communication with the upper outlet end of tube 53. In the FIGS. 1-4 embodiment, and preferably in all embodiments, the nozzle 53 is positioned rearwardly from and between the blades 46 and 48, such blades preferably forming a spray head accommodating opening 57 at their rearward or trailing edges. Both the knife element 47 and the nozzle element 59 of the knife and nozzle component are mounted upon and are supported by a base plate 50, the distal or lower and rearward ends of the blades 46 and 48 being directly mounted to plate 50. Support struts 52 and 54 preferably centrally support the nozzle element from plate 50.

Referring further simultaneously to FIGS. 1-4, the instant inventive assembly 1 preferably further comprises a first conduit 78 whose outlet end communicates with the lower inlet end of the nozzle 59. In a preferred embodiment, the conduit 78 comprises a flexible and chemical resistant hose.

A further structural element of the instant inventive assembly comprises a bracket component which is operatively mounted and positioned within processing space 3. Such bracket component suitably comprises a combination of a pair of laterally extending container support beams 26 and 36 and an upper slide stopping member. In the FIGS. 1-4 configuration, the bracket component's upper slide stopping member advantageously comprises the ceiling's lid 14.

In operation of the bracket variant 26,36,14, of FIGS. 1-4, an operator may vertically position crossbeams 26 and 36 below the lid 14 and at an elevation substantially coinciding with that which underlies the closed lid 14 a distance equal to the vertical height of the chemical container 80. Lateral and oppositely—lateral frame mounted and supported slide flanges 7 and 5 may be provided for facilitating such vertical adjustability of the crossbeams 26 and 36. Such flanges 7 and 5 may be engaged and clamped by clevis and set screw combinations 28,30, and 32,34, and 38,40, and 42,44 which allow the operator to securely and selectively position the crossbeams 26 and 28 at elevations which correspond with any of the vertical heights of several differing types of chemical containers 80.

A turn latch assembly 18,20,21 is preferably provided for alternatively opening and securely closing the lid 14. Upon opening of the lid 14, the operator may insert container 80 into the processing space 3 for bracket support wherein the base of the container 80 rests upon the upper surfaces of crossbeams 26 and 36. Thereafter, the operator may close the lid 14 and may turn latch 18,20,21 to secure the lid 14 at its closed position. Upon such closure and latching, the lid 14 advantageously functions as a further structural element of the bracket component which further supports the container 80 by resisting any upward deflection of the container 80 during incising engagement with blades 46 and 48.

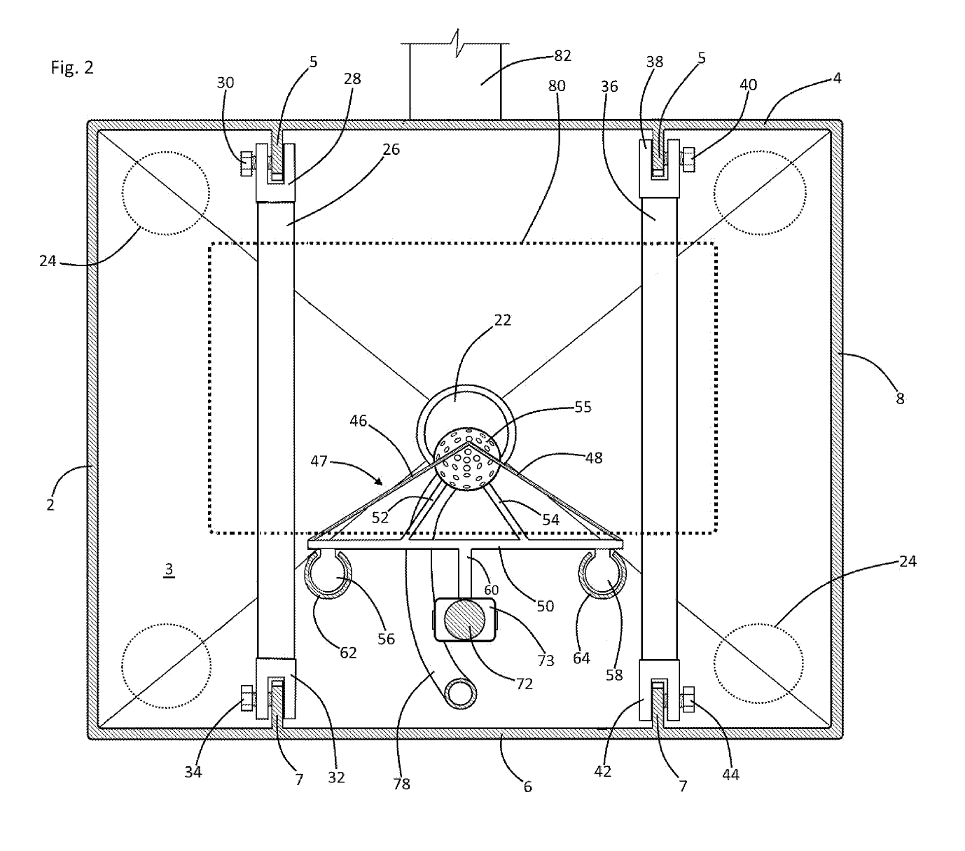

Referring further to FIGS. 1-4, the instant inventive assembly preferably further comprises a motion actuator which is positioned for operation within the chemical container processing space 3. In the FIGS. 1-4 embodiment, the assembly's motion actuator comprises one or more slide tracks 62 and 64 which slidably receive and vertically guide the motions of slide members 56,58. Slide members 56 and 58 are intended as being representative of track guided rollable elements such as ball bearings or wheels which may be suitably substituted. As indicated in FIGS. 2 and 3, slide elements 56,58 are rigidly mounted upon and are supported by the base plate 50 of the knife and nozzle component 47,59. Such mechanical interrelationship between the knife and nozzle 47,59 and the slide tracks 62 and 64 requires that alternate upward and downward sliding movements of slide elements 56,58 within slide tracks 62,64 correspond with vertical upward and downward movements of the knife and nozzle component.

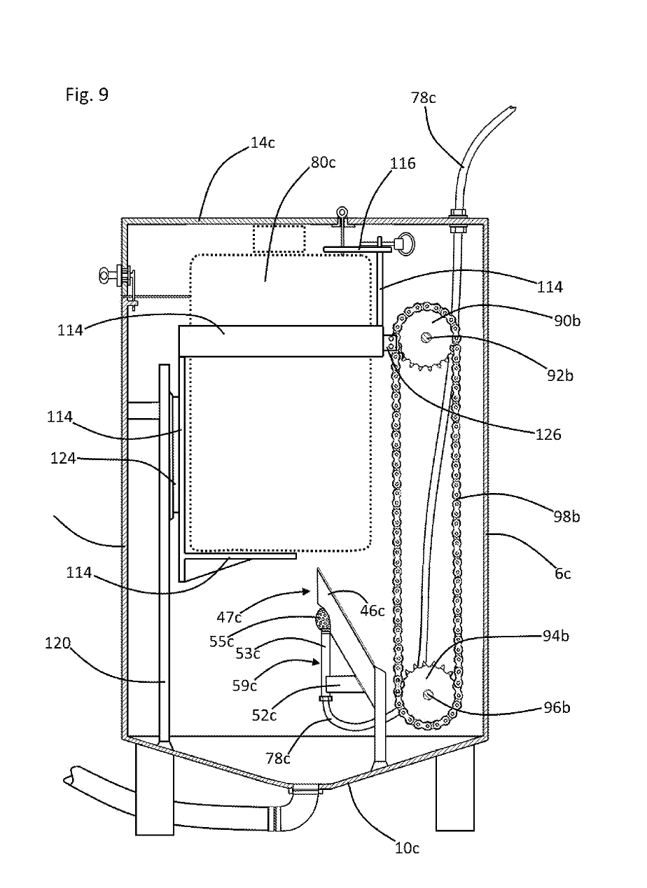

Referring simultaneously to FIGS. 1-4 and FIG. 9, all reference numerals in FIG. 9 having the suffix “c” are configured substantially identically with similarly numbered structures appearing in FIGS. 1-4. In the FIG. 9 variant, the assembly's bracket component is alternatively configured to include a vertically moveable container receiving frame 114 which incorporates an upper container securing and releasing element 118. Slide tracks 120 and slidably received elements 124 are mounted within processing space 3c, such tracks functioning similarly with slide tracks and slide elements 56,58,62,64, of the FIGS. 1-4 motion actuator variant. In contrast with the FIGS. 1-4 motion actuator variant which facilitates vertical motions of the knife and nozzle component, the FIG. 9 motion actuator components 120,124 engage and vertically guide vertical motions of the bracket component 114,118.

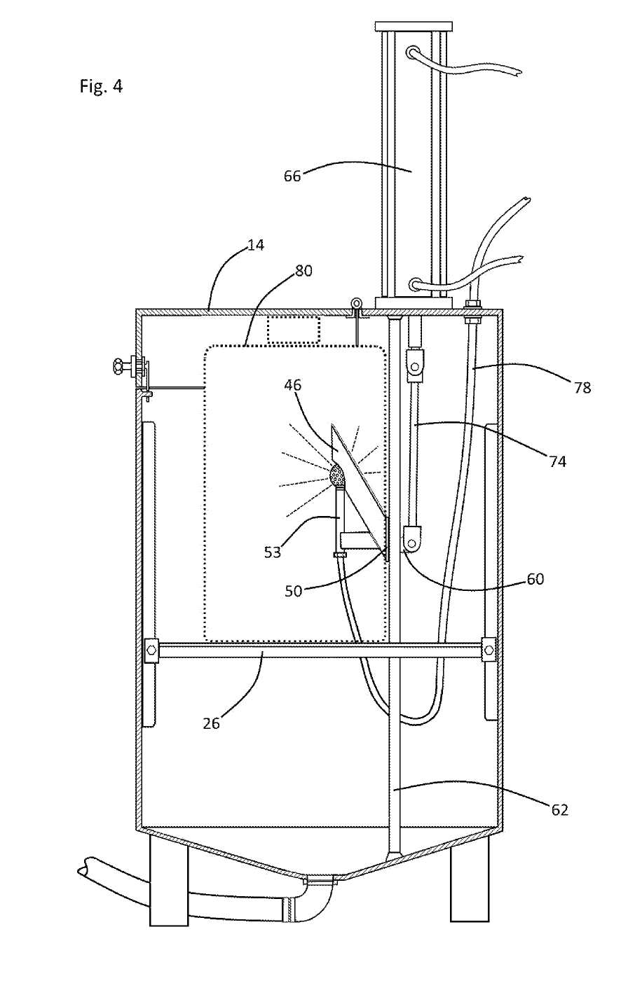

As is shown by the FIGS. 1-4 and FIG. 9 variants, the instant inventive assembly's motion actuator operatively interconnects the frame and a component selected from the group consisting of the knife and nozzle component (e.g., knife and nozzle 47,59) and the bracket component (e.g. bracket 114,118). In the FIGS. 1-4 variant, the selected component which is operatively interconnected by the motion actuator (e.g., slide tracks and slide elements 56,58,63,64) constitutes the knife and nozzle 47,59, and upon slidable guidance of the knife and nozzle component 47,59 to the upwardly displaced or second position depicted in FIG. 4, blades 46 and 48 effectively incise the floor and side wall of chemical container 80, allowing fluids within the container 80 to purge outwardly and downwardly within processing space 3. While the knife and nozzle component 47,59, remains at its second position, the nozzle's spray head 55 is advantageously positioned within the interior of container 80 for spraying of rinse water against the container's interior surfaces. A subsequent downwardly displacement of the knife and nozzle component 47,59 from the FIG. 4 second position to the lowered position depicted in FIG. 3 constitutes movement toward a first position. Such downward movement disengages the knife and nozzle component 47,49 from the purged and rinsed container 80, and allows, upon opening of lid 14, for extraction of the container 80 from the interior processing space 3.

The downwardly angled and laterally canted cutting edges of blades 46 and 48 effectively urge or drive the container 80 laterally toward and against plate 50 as blades 46 and 48 upwardly execute their container wall incising motions. Such lateral container driving effect further securely holds the container 80 during incising. Accordingly, such plate 50 during incising operation of blades 46 and 48 constitutes a further functional component of the assembly's container supporting bracket component.

In the FIG. 9 variant, wherein the selected component which is operatively connected by the motion actuator (e.g., slide track elements 120,124) constitutes the vertically moveable bracket component 114,118, such selected component is depicted as occupying an upper first position which precedes incising engagement with knife 47c. Upon downward motion actuator guided movements of bracket component 114,118, and of container 80c, incising engagement of the knife element 47c with the container 80c occurs. Upon full incising engagement, the knife and nozzle component 47c, 49c and bracket 114,118 effectively occupy a second position with respect to each other.

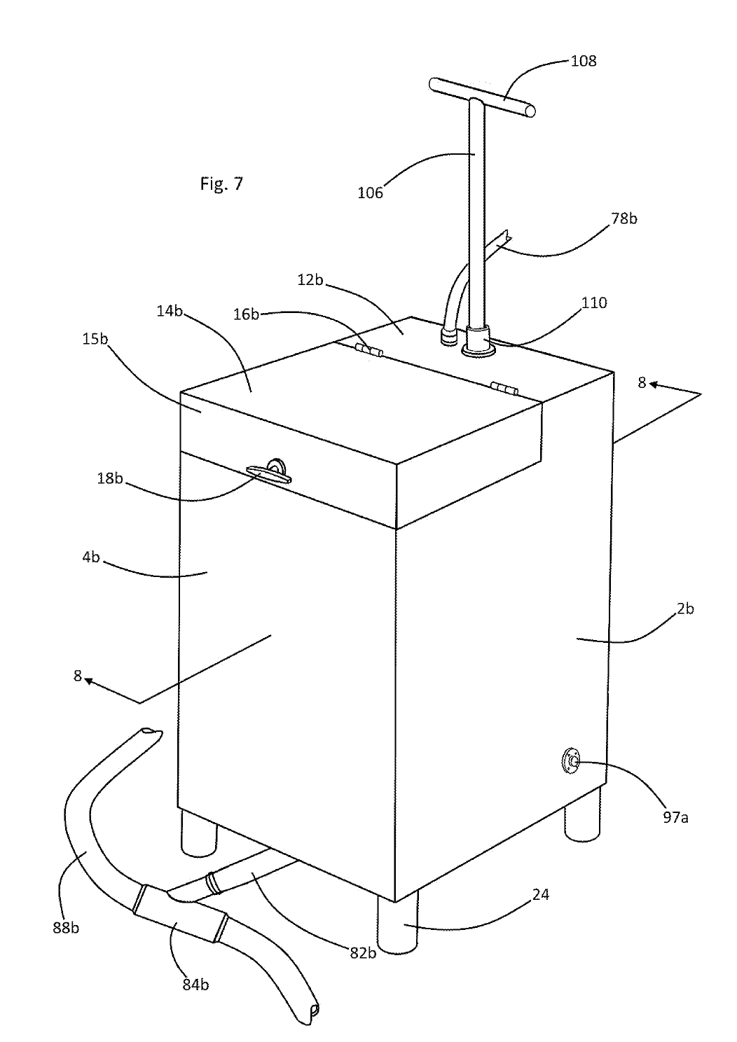

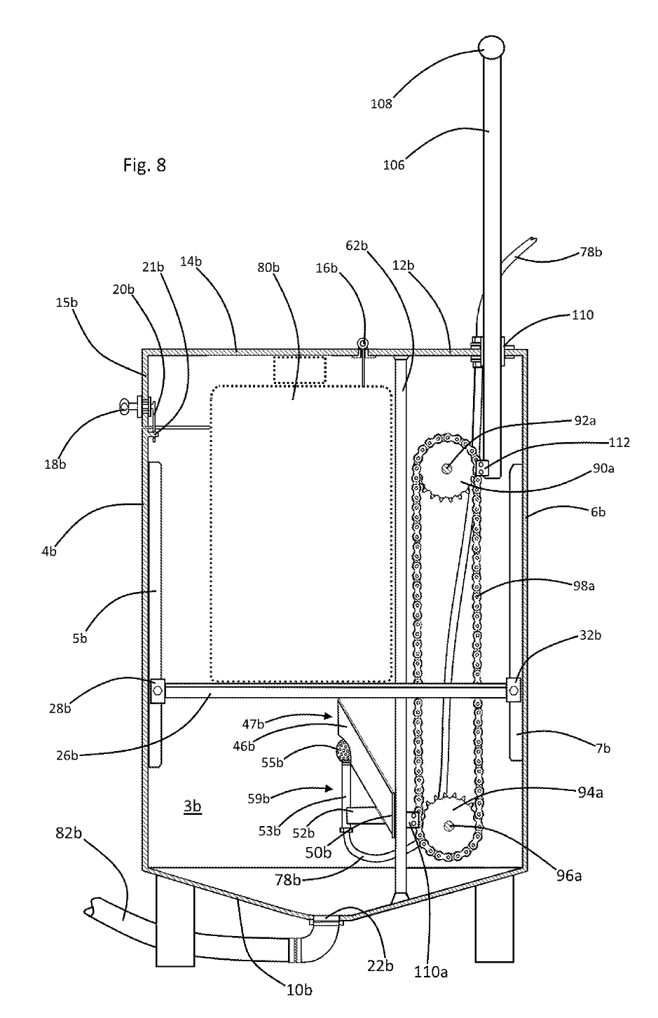

Referring simultaneously to all figures, the motion actuator component of the instant inventive assembly 1 may suitably guide the driven and moveable component along an arcuate or circular path such as that which is traced by the distal end of a pivoting arm (not depicted within views). The motion actuator may further suitably, and alternatively comprise a linear motion actuator which constitutes a combination of a pneumatic cylinder 66 mounted at an upper position upon ceiling 12 in combination with a retractable and extendable piston shaft 72. Preferably, the cylinder 66 constitutes a two way cylinder having pressurized fluid carrying lines 68 and 70 positioned at either side of an internal piston. A link 74 which spans between and interconnects joints 73 and 75 effectively mechanically interconnects the lower end of piston shaft 72 with an eyed mounting flange 60 which is fixedly attached to and extends laterally from plate 50. Operation of the pneumatic cylinder 66 to alternately retract and extend shaft 72 effectively drives the knife and nozzle component 47,59 between the first and second positions respectively represented in Drawing FIGS. 3 and 4. The pneumatic cylinder 66 is intended as being representative of an hydraulic cylinder which may be suitably substituted and utilized. Such cylinder 66, including shaft 72, is intended as being further representative of a simple manually actuatable pull handle (potentially configured similarly with the “T” handle and shaft 108 and 106 depicted in FIGS. 7 and 8).

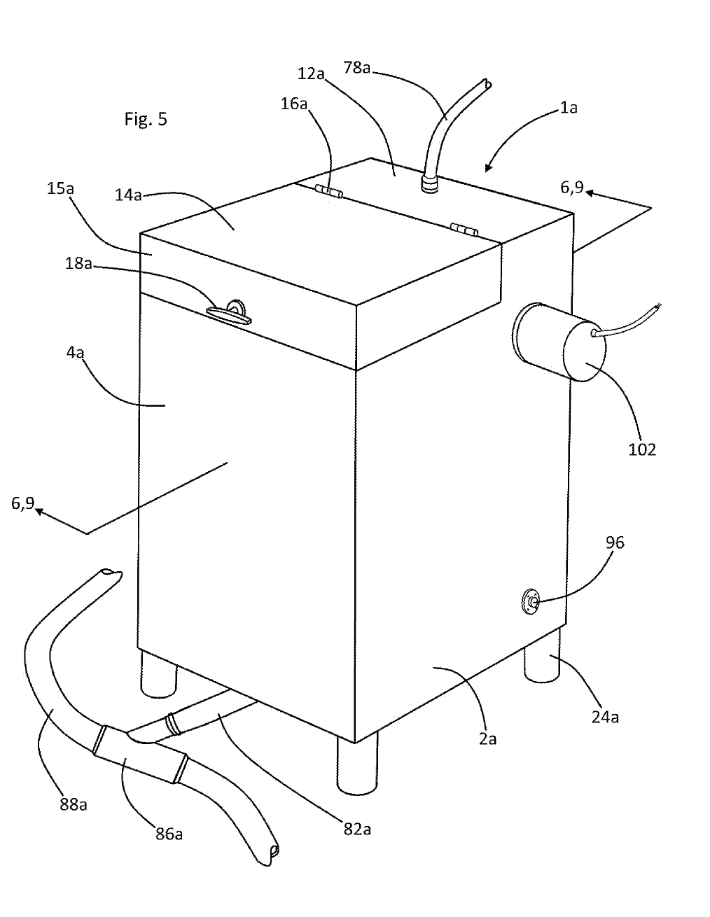

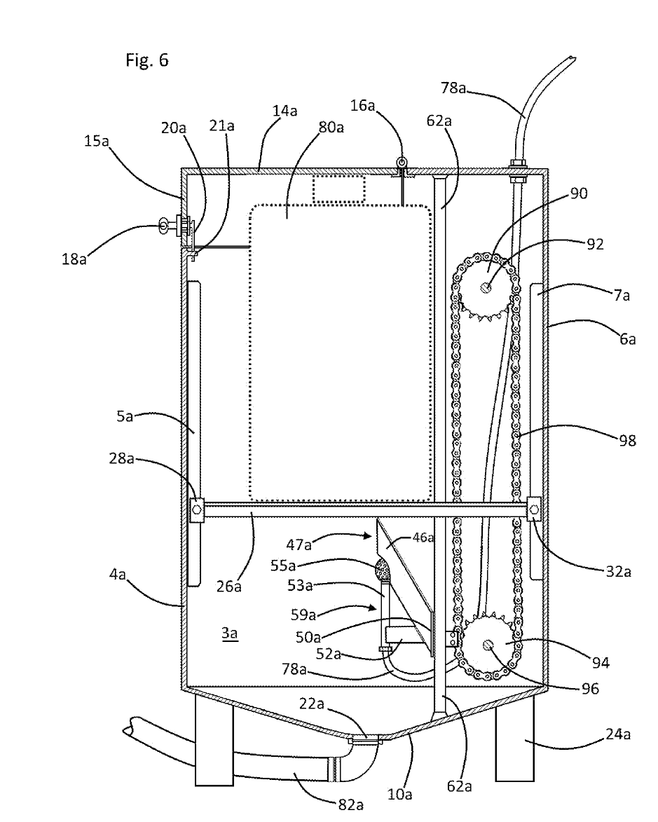

Referring simultaneously to FIGS. 5 and 6, all structures identified by a reference numeral having a suffix “a” are configured substantially identically with similarly numbered structures appearing in pgs. 1-4. In the FIGS. 5 and 6 variant, the motion actuator element of the inventive assembly comprises a linear motion actuator which incorporates upper and lower sprockets 90 and 94, and continuous loop chain 98. In the FIGS. 5 and 6 actuator variant, chain 98 may be operatively connected with and may engage plate 50a via link 100. In such actuator variant, sprockets 90 and 94 may be rotatably supported within interior space 3a by transversely extending axles 92 and 96. The sprockets 90,94, and continuous loop chain 98 are intended as being representative of a belt and pulleys combination which may be suitably substituted, and such sprockets and chain are further intended as being representative of various trains of toothed gears. As the sprockets 90,94 inherently incorporate and comprise pivot arm actuators, the depicted sprockets are further intended as being representative of pivot arm actuators.

The FIGS. 5 and 6 linear motion actuator variant may suitably incorporate a frame wall mounted reversible electric motor 102 whose output is in rotary driving communication with axle 92. Rotations and counter-rotations of axle 92, driven by electric motor 102 alternatively drive the knife and nozzle component 47a, 59a between first and second positions in a manner similar to the above described linear motion actuating function of the two way cylinder 66. The reversible electric motor 102 is intended as being representative of hydraulic and pneumatic motors, and as being further representative of manually turnable turn wheels, turn handles, turn levers, and turn cranks.

Referring to FIG. 8, all structures identified by reference numerals having the suffix “a” are configured similarly with similarly numbered structures appearing in FIG. 6, and structures identified by reference numerals having the suffix “b” are configured similarly with similarly numbered structures appearing in FIGS. 1-4. In the FIG. 8 variant, the motion actuator element comprises a plunger linear motion actuator 106,108, such plunger extending through a slide sleeve 110 within ceiling 12b. The lower end of plunger shaft 106 may engage chain 98a via link 112, and reciprocating and manually driven downward and upward motions of the plunger 106,108 through sleeve 110 may induce upward and downward linear motions in the knife and nozzle component 47b,59b. The plunger 106 and slide sleeve 110 combination is intended as being representative of screw shaft and helically threaded coupling nut actuators.

Referring to FIGS. 1-4, fluid chemicals purged from container 80 downwardly pass through port 22 and into a second outlet conduit 82 which carries the purged chemicals away from the frame. In the FIGS. 1-4 embodiment, the second conduit 82 communicates with a third conduit 84 by means of an angled venturi or back flow resisting joint 86. Water carried by the third conduit 84 for filling of, for example, an agricultural chemical tank such as tank 134 appearing in FIG. 10, may advantageously carry the purged fluid chemicals from the assembly 1 to such tank 134.

While the principles of the invention have been made clear in the above illustrative embodiment, those skilled in the art may make modifications in the structure, arrangement, portions and components of the invention without departing from those principles. Accordingly, it is intended that the description and drawings be interpreted as illustrative and not in the limiting sense, and that the invention be given a scope at least commensurate with the appended claims.

The invention hereby claimed is:

1: An assembly for incising, purging, and water rinsing a chemical container, the assembly comprising:
(a) a frame defining a processing space;
(b) a knife and nozzle component within the processing space, said component's knife having a forward cutting edge and said component's nozzle being positioned rearwardly from the forward cutting edge;
(c) a first conduit communicating with the blade and nozzle component's nozzle;
(d) a bracket component within the processing space, said component being adapted for supporting the chemical container;
(e) a motion actuator within the processing space, the motion actuator operatively interconnecting the frame and a component selected from the group consisting of the knife and nozzle component and the bracket component, the motion actuator being adapted for, upon the bracket component's support of the chemical container, moving the selected component between first and second positions, the blade and nozzle component residing within the chemical container upon movement to the second position, the blade and nozzle component and chemical container being displaced from each other upon movement to the first position.

2: The assembly of claim 1 wherein the knife and nozzle component's knife comprises a pair of blades, said component further positioning the nozzle between said blades.

3: The assembly of claim 2 wherein the conduit comprises a flexible hose adapted for carrying the water into the processing space.

4: The assembly of claim 3 wherein the motion actuator comprises a track adapted for guiding a sliding or rolling element.

5: The assembly of claim 4 wherein the motion actuator further comprises a linear motion actuator selected from the group consisting of pneumatic cylinders, hydraulic cylinders, chain and sprocket combinations, pulley and belt combinations, gear trains, pivoting lever arm actuators, plunger actuators, pull handle actuators, electric motor actuators, pneumatic motor actuators, hydraulic motor actuators, and screw actuators.

6: The assembly of claim 5 wherein the frame comprises a lid and wherein the bracket comprises an upper slide stop, the upper slide stop comprising the lid.

7: The assembly of claim 5 wherein the blades among the knife's pair of blades are arranged in an inverted “V” configuration.

8: The assembly of claim 7 wherein the blades among the knife's pair of blades are laterally canted.

9: The assembly of claim 5 wherein the frame comprises a fluid collecting floor having an outlet port.

10: The assembly of claim 9 further comprising second conduit, the second conduit communicating with the outlet port.

11: The assembly of claim 10 wherein the second conduit has an outlet end and further comprising a third conduit and a venturi joint, the venturi joint interconnecting the second and third conduits.

12: The assembly of claim 5 wherein the frame comprises an open lattice fitted for positioning and operation within an agricultural chemical tank.

13: The assembly of claim 12 further comprising tank mounting means connected operatively to the frame.

14: The assembly of claim 13 wherein the tank mounting means comprise a plurality of suspension hooks.
